(19) United States
(12) Patent Application Publication
(10) Pub. No.: US 2024/0090990 A1
(43) Pub. Date: Mar. 21, 2024

(54) SYSTEM FOR MONITORING A CALVING MAMMAL

(71) Applicant: LELY PATENT N.V., Maassluis (NL)

(72) Inventors: Adrianus Cornelis Maria MEEUWESEN, Zegge (NL); Yan LI, Delft (NL); Ananthu ANIRAJ, Rotterdam (NL)

(73) Assignee: LELY PATENT N.V., Maassluis (NL)

(21) Appl. No.: 18/262,141

(22) PCT Filed: Feb. 10, 2022
(86) PCT No.: PCT/IB2022/051204

§ 371 Date: Jul. 19, 2023

(30) Foreign Application Priority Data
Feb. 15, 2021 (NL) 2027558

(51) Int. Cl. A61D 17/00

(52) U.S. Cl. CPC A61D 17/008

(57) ABSTRACT

A calving monitoring system for monitoring an animal at the end of the expected gestation period includes a camera device for repeatedly taking images of the animal, a control unit for generating calving information from the images taken, and an alert device for sending an alert message according to the calving information generated. The control unit is configured so as, in each image taken, to recognize an animal image, to segment the animal image into multiple animal parts including a torso, to determine a parameter value relating to first pixels of said torso in the taken images as a time-dependent parametric function, and to detect contractions when the parameter value meets a predetermined contraction criterion. The criterion is that the parameter value exhibits at least two peaks in the predetermined time duration which have at least a predetermined minimum width and/or a predetermined minimum height.

The present invention relates to a calving monitoring system for monitoring an animal at the end of the expected gestation period, comprising a camera device for repeatedly taking images of the animal, said images being composed of pixels, a control unit for the calving monitoring system, connected to the camera device, which is configured to generate calving information from the images taken, and an alert device for sending an alert message according to the calving information generated, wherein the control unit is configured so as, in each image taken, to determine a parameter value relating to first pixels of said taken images as a time-dependent parametric function, and to detect contractions when said parameter value meets a predetermined contraction criterion, wherein the control unit generates calving information which comprises an indicator of the contractions detected.

Document WO2017034391 describes a device for automatically detecting calving. For this, the device monitors the pregnant animal using a 3D camera and, from the 3D images, calculates a contraction parameter, such as a change in volume over time, from distances between a body surface and a central point of the body. On the basis of the frequency and/or intensity of these changes in volume, it is possible to predict the moment of calving.

A drawback of the known device, and the corresponding method, is that the 3D camera, which typically has a limited angular aperture, has to be positioned high enough above the animal that the—often large—animal still remains in the image if it moves. Consequently, the image distance will be at least a few metres, which is bad for sensitivity, resolution and reliability of the 3D image. Additionally, the 3D camera is often sensitive to sunlight, and straw or other bedding material, which is necessary in a calving pen, also often interferes with the image. Calculating the volume also requires substantial computing power. Additionally, determining a change in volume is by no means always a reliable indicator of contractions. Furthermore, no method is given for filtering out real changes in volume such as breathing, urination and/or defecation, nor is any indication given as to how to determine what in the volume signal does and does not indicate a contraction.

An aim of the present invention is to solve, at least in part, the above-mentioned problems.

More particularly, an aim of the present invention is to provide a reliable, alternative device for monitoring the calving of mammals, in particular for detecting contractions in calving mammals.

The invention achieves this aim with a system according to claim 1, in particular a calving monitoring system for monitoring an animal at the end of the expected gestation period, comprising a camera device for repeatedly taking images of the animal over a predetermined time duration, said images being composed of pixels, a control unit for the calving monitoring system, connected to the camera device, which is configured to generate calving information from the images taken, and an alert device for sending an alert message according to the calving information generated, wherein the control unit is configured so as, in each image taken, to recognise an animal image, to segment said animal image into multiple animal parts including a torso, to determine a parameter value relating to first pixels of said torso in said taken images as a time-dependent parametric function, wherein said at least one parameter value comprises a width value of the torso, and to detect contractions when said parameter value meets a predetermined contraction criterion, the criterion being that the parameter value exhibits at least two peaks in said predetermined time duration which have at least a predetermined minimum width and/or a predetermined minimum height, wherein the control unit generates calving information which comprises an indicator of the contractions detected.

The invention makes use of the insight that at least the step of detecting animal parts, after an initial learning step, is relatively straightforward to accomplish. The steps to be carried out subsequently on the animal part recognised as the torso are likewise relatively straightforward. In addition, the criterion of the at least two peaks with a minimum width and/or height makes it relatively straightforward to filter out non-periodic movements, such as the animal moving, urination and defecation in a straightforward manner, while breathing is likewise readily recognisable and thus can be filtered out. Although an individually occurring contraction will thus not be detected, if such does occur it will virtually always be at a very early stage of calving, and because it is more difficult to distinguish such from a random other one-off fluctuation, the omission of the individually occurring contraction will increase the reliability of detection of real (multiple) contractions.

A great advantage of the present invention is that it is possible to use not just a 3D camera but also an ordinary 2D video camera as the camera. In fact, 2D cameras are even preferred because of the higher image frequency, resolution, availability of image processing software, etc.

The images taken are processed by an image processing device, which may typically form part of the control unit but may also be provided as a separate module. The image processing device, or at least the control unit, is configured to recognise an animal image in the image taken. For this, the image processing device comprises, for example, a software module that is trained to recognise the target animal type, such as dairy cows, beef cows, mares, ewes, goats, or even other large animal types, such as equids, bovids, cervids, etc. in zoos and breeding programmes. Only dairy cows will be mentioned further in the present description of the invention, but this is not limiting. The software module can be trained using neural networks, as known per se in the prior art. The training may have taken place beforehand in one or more test setups, followed by installation of the module in the calving monitoring system, or even in the present system itself.

The recognition of an animal image in the image taken is a first step. Moreover, it is possible for multiple animal images to be recognised in the image. However, if the pregnant animal is alone in a pen, such as in a separate calving pen, which is then also advantageously part of the present calving monitoring system, there will always be only one animal visible in any case, at least prior to calving. It will therefore be straightforward to ensure that the animal is completely visible, and thus that the animal image should in principle always be successfully recognised.

In a next step, the animal image is segmented into various animal parts. At least a torso is recognised in the recognised animal image. This can be by actually explicitly recognising different separate animal parts, such as a head, legs and an udder or other milk-producing organs. However, it is also possible to recognise just two animal parts, namely the torso and the rest of the animal. It should be noted that not all of the same animal parts will always be visible. Thus, the udder will not be visible in the case of a standing animal in an image from above. To recognise the torso, the image processing device may have previously been trained using, for example, a neural network, or an algorithm based on the results thereof. Moreover, it should be noted here that steps such as noise reduction, etc. are assumed to be known per se.

The parameter value used is the width value of the torso. The width value is, for example, the largest measurement from the left-hand side to the right-hand side of the torso. Further details regarding this are given below. It is noted that not only can the width measurement be determined very straightforwardly and reliably in the animal image, but it is also considered to be a more reliable measurement for contractions than volume. Indeed, in the case of contractions, it is not so much the volume of the torso that changes as the shape, i.e. the outer dimensions. As the muscles contract, the width value changes, and as the muscles relax, they return to more or less the initial value. The value therefore exhibits a peak. To be able to reliably discern such a peak in the parametric signal (the function), a number of constraints are imposed. The control unit recognises a contraction if the peak has at least a minimum time duration (i.e. a minimum peak width in the width value as a function of time) and/or at least a minimum height (i.e. a minimum absolute or percentage change in value), and also if at least two such peaks occur in the time duration over which images are taken. This makes use of the insight that contractions often, if not usually, occur in waves, and thus individually occurring phenomena, such as an animal moving about, urinating, or defecating, can simply be excluded.

It should be noted that the peak behaviour, i.e. the occurrence of a peak after which the parameter value at least approximately returns to an initial value, is characteristic of a contraction. While a live animal will often move spontaneously, contractions are characterised in that they occur repeatedly and comprise a movement in one direction followed by a movement back in the other direction. By recognising movements with respect to a reference, and filtering using these criteria (also already described above), contractions can be detected reliably. Further details regarding this will be provided below.

The time duration over which images are taken is then preferably adapted to the time between contractions, naturally such that at least two contractions can also be detected. This time can be chosen according to the type of animal, and can be between, for example, ten and twenty seconds, such as around fifteen seconds, in the case of dairy cows. After the time duration has elapsed, it is possible to start a new period, for example of the same length, and to take the images and perform the measurements therein. In particular, the time duration is a running time duration, wherein after each taking of an image a preceding period/time duration is determined anew, as well as which images have been taken in this preceding period. This new group of images then serves as the basis for new calculations. Thus, the control unit always has the newest, most up-to-date data, on which to base the required calculations. For this, it is of course possible to apply the contraction information calculated over each period for a point in time, such as in particular the point in time of the newest image of the current time duration. The evolution with time, or as a function of time, of the contraction and calving information can therefore be readily determined by the control unit.

What is meant by “the calving information comprises an indicator of the contractions detected” is that the calving information generated contains information regarding the contractions detected in the form of, for example, start and end points of all of the contractions detected, optionally of a peak height (i.e. intensity), or of the number or the frequency, or the length of the individual contractions, or the total cumulative time duration of the contractions, in each case either in a determined preceding time duration or in total. In principle, any indicator that is an indication of calving or the stage of calving is sufficient.

Depending on the calving information generated, the alert device sends an alert message. For this, it is possible to envisage sending a “first contractions detected” message, or an alert indicating that a contraction-related threshold has been exceeded, etc. The user of the system can set this themselves, for example depending on the animal, or depending on the distance between where the user is staying and where the calving animal is staying. For this, the alert device can be configured to send an SMS, email or other (push) message, to issue a sound signal, etc. All of this will be explained in more detail below.

Particular embodiments are described in the dependent claims, and in the following introductory part of the description.

In general, the invention relates to measurements on the torso of the animal. Advantageously, said first pixels are all in a part, in particular half, of the torso located at a rearmost end of the animal image. This has the advantage that the measurements are further limited to the part of the body where the contractions will occur, namely the abdomen. In this way, breathing, for example, can be even better suppressed in the measurements. The rearmost part of the torso is the part of the torso at the opposite end to the head, i.e. the part of the torso at the tail end. All of this is straightforward to train for the image processing device. Furthermore, “half” in this respect does not necessarily have to be understood as exactly 50% of the torso, but rather as the relevant part thereof. If desired, the image processing device, or at least the control unit, can be trained further so that it takes only the pixels of the part relevant for contractions into consideration. For example, this may actually concern the rearmost 50% (or another percentage) of the pixels, or even a part of the torso somewhat away from the tail end. On the basis of practical tests and measurements, and depending on the type of animal, the breed or even the individual animal, the most relevant part can thus be determined. In this way, the control unit can detect contractions more reliably, by omitting irrelevant parts and changes therein. Thus, it is more advantageously possible for the control unit to be configured to study pixels in (only) the part of the torso located between the udder and a perpendicular bisector of the longitudinal axis of the animal. It is relatively straightforward for the control unit to determine this part of the torso, by first determining the longitudinal axis of the torso, followed by a perpendicular bisector thereof, and recognising the udder (if visible in the image, of course). The part to be studied is then located in between. Alternatively, it is also possible for the control unit to be configured to consider the third quarter of the torso when viewed in the longitudinal direction, i.e. the half of the tail-end half of the torso that is closest to the head end. In all of these and still many more ways, the control unit can be configured to consider (only) pixels of the most appropriate part of the torso, namely that part where the clearest contractions are expected. This part can also be roughly defined as “around the navel”. In particular, the contractions are clearly visible here as contractions in the direction of the spine and back again.

As already mentioned above, the width of the torso, or of a relevant part thereof, is the parameter according to the invention. The width is usually, and advantageously, measured from above, because that is the most straightforward and also the most reliable. In principle, the width value is determined in this case as substantially transverse to the longitudinal axis, where the longitudinal axis is of course the longest dimension of the torso or of the animal, as the case may be. Therefore, the control unit is in particular configured to determine a longitudinal direction of the torso, and to determine the width value as equal, or proportional, to the width measured substantially transverse to the longitudinal direction.

It should be noted that the animal may be standing, in which case the image sees the back from above, or it may be lying down, and either more or less on its side or mainly on its belly. In all such cases, the width value can still be kept as the parameter for recognising contractions. Only when the animal changes posture, such as from standing to lying, will the width value be unusable for some time due to the relatively large change in shape, although this should not last longer than a few seconds. Moreover, the posture of the animal, in combination with the contractions, can also provide calving information. Thus, contractions measured while standing may suggest that calving is going relatively smoothly.

In order to obtain the most relevant possible parameter value, it is advantageous if the control unit is configured to determine the width value at one and the same longitudinal position of the torso each time, in particular for one and the same attitude of the animal, such as standing or lying. Indeed, it might happen that the spot of the largest width shifts to another position due to the change in shape of the torso, which can cause deviations in measurement. For example, it is advantageous to determine the spot of the largest width in a rest period, i.e. a period without contractions, and subsequently to determine the width at this spot each time. Alternatively or in addition, it is possible to determine, on the basis of practical measurements, at which one or more spots there is the clearest variation in width during contractions, in order thereby to configure the control unit to determine the width at these one or more spots each time. The control unit is then advantageously configured to measure the width at these one or more spots (averaged over the spots). In this way, a contraction can be even more reliably determined. Alternatively, it is possible for the control unit to be configured to each time determine the width in each newly taken image on the perpendicular bisector of the longitudinal axis of the torso. For this, the longitudinal axis can be taken as the longest axis in the torso detected, and the width is then the length of the perpendicular bisector of the longitudinal axis in the image of the torso. This measurement is relatively straightforward to arrange. However, it is possible that, for example, the cow bending to the side can mean that the longitudinal axis of the torso comes to be located elsewhere, and that, as a result, the width-to-length ratio is distorted, but it is again emphasised here that the periodicity of the contractions is an important characteristic, which should be clear enough in the measurements. Even if a single contraction is missed due to, for example, such a lateral movement of the animal, the reliability of detection of uninterrupted contractions will be high.

Moreover, it is also not necessary to determine the exact, absolute width. In principle it is sufficient, in order to determine contractions, to determine changes in the width, i.e. the relative width. In the case that the animal is located in a calving pen, for example, and moves, the width visible in the image will also change. It is then difficult to determine the absolute width, and in fact not necessary to do so in order to be able to determine changes in the width. Therefore, in embodiments, the width value is a normalised width value, in particular equal to said width of the torso divided by a length of the torso measured along the longitudinal direction. Thus, as a good approximation, even the animal moving in the camera image will have little or no effect on the detection of contractions.

In what has been described above, the calving monitoring system, or at least the control unit, makes use of the insight that contractions are distinguishable from many other movements because they are periodic. Furthermore, depending on the type of animal, etc., criteria can be set for the intensity and length in terms of time of a parameter value signal indicative of a contraction in order to deem a peak to be a contraction. However, it is possible to provide the control unit with further instructions in order to refine the assessment of the parameter value. In embodiments, the control unit is further configured to carry out an analysis of said parametric function, comprising fitting a periodic function with a period p to said parametric function, and to determine at least one fit parameter value of a fit parameter, which comprises in particular at least one of the difference between the fitted function and the parametric function, and the correlation between the fitted function and the parametric function, and to correct the contractions detected, in particular the number of contractions, according to said at least one fit parameter value. For this, use is made of the following insight. Contractions are generally periodic events. Therefore, a signal that indicates such contractions will likewise be periodic. This means that a periodic function can be fitted to the signal with, of course, the same period, denoted by p. Moreover, p should have a value that suits contractions, such as 3 to 10 seconds, in particular 3 to 6 seconds. According to these embodiments, what is used as the fit parameter value for the signal and the related fitted function is the difference between the signal, i.e. the parameter value determined from the images, and the fitted function and/or the correlation between them both. If the fit parameter value is relatively small or relatively large (towards 1), then it follows from this analysis that there is a high chance that the peaks observed correspond to real contractions, and if not, then there is a high chance that there are no contractions and it should thus be corrected, i.e. ignored. More generally, the control unit is thus configured to correct the parameter value signal, and the contractions therein, using the fit parameter value.

Moreover, still many more refinements to this analysis are possible, using which the control unit can clean up the parameter value signal by filtering out false-positive contractions therefrom, and recognising true-positive contractions.

In embodiments, the alert device is configured to send a calving phase warning if, and in particular when, a frequency of the contractions detected and/or a total length of time of the contractions detected, in each case over at least an immediately preceding, predetermined observation period, reaches or exceeds a predetermined frequency threshold or first time threshold, respectively. In additional or alternative embodiments, the alert device is configured to send a calving difficulty warning if, and in particular when, the time duration over which the control unit detects contractions, i.e. including the time between contractions, reaches a predetermined threshold calving duration. The calving monitoring system can be used to inform the user of various phases in the calving, and potentially of difficulties during calving, all of this depending on the calving information. After the contractions get going, calving will often be completed within a time of between half an hour and an hour and a half. Based on that, the user can plan their presence, if desired. It is also possible, if the control unit detects contractions over a longer time than a threshold time chosen by the user, and/or if the contractions fail to happen after some time lasting at least a predetermined time duration, to have the alert device send a “difficult calving” warning or similar. Contractions, or pushing, stopping is often caused by the calf being in breech, there being a leg back or another position that is unfavourable for calving, or there being a twin, or the calf being (too) large, etc.

The invention will now be explained in more detail with reference to some non-limiting examples, and to the drawing and the corresponding description of the figures. These show:

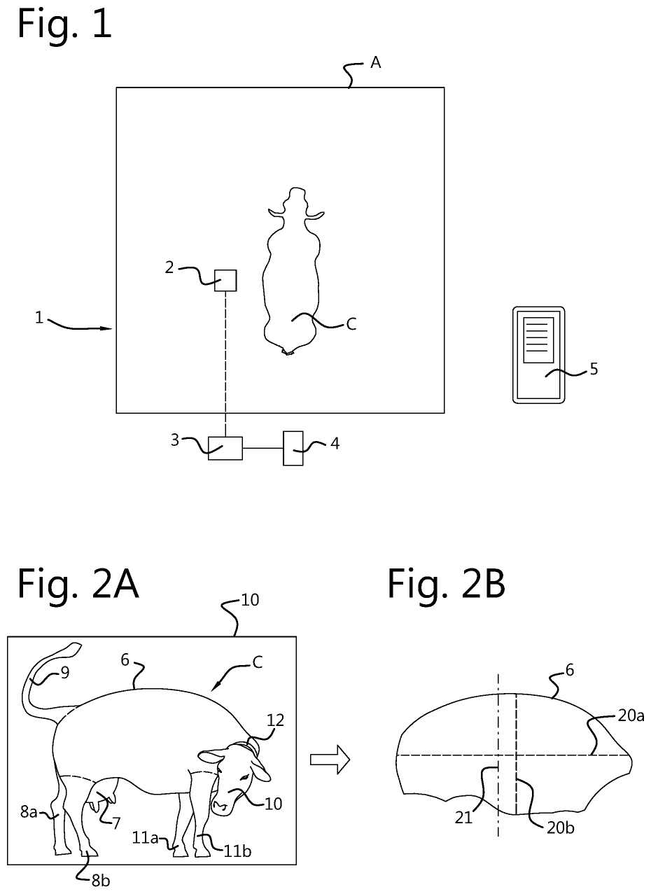

FIG. 1, a diagrammatic top view of a system according to the invention;

FIG. 2A, an example of a camera image;

FIG. 2B, a torso from this image; and

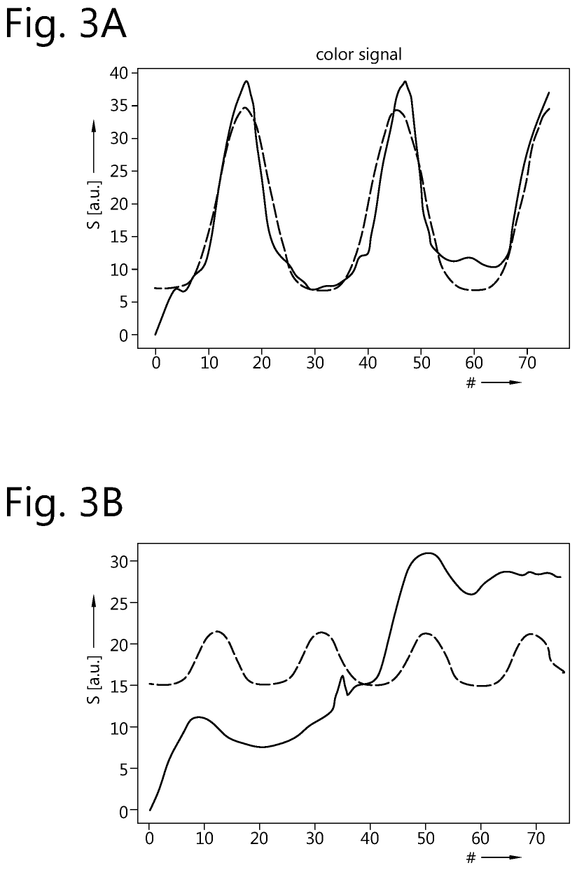

FIGS. 3A and 3B, a respective diagram in which the signals determined are plotted against time and against a fitted function in each case.

FIG. 1 shows a diagrammatic top view of a calving monitoring system 1 according to the invention. The system comprises a camera 2 and a control unit 3 with an alert device 4, in a calving pen A for a cow C. 5 indicates a mobile telephone.

The camera 2 can be an ordinary video camera, either a monochromatic or colour video camera. The latter is preferred because that provides more information, which can help, for example, in recognising the animal and animal parts therein. It is also possible to use a (digital) still camera as the camera 2, given that it is not necessary for the invention to record images at video frequency (>15 images/second). It is sufficient in most cases to record, for example, a few images per second, for which purpose still cameras may also be suitable.

The camera 2 is suspended above inside a calving pen A, in which there is one cow C which is due to calve. It is of course possible for more cows or other animals, such as horses, goats, sheep, and the like to be placed in one calving pen, but not only can this be more stressful for many animals, it also makes recognising the animals in the image from the camera 2 more difficult.

The camera 2 takes an image of the calving pen A, and thus of the cow C, every 0.2 second, for example. The images are sent to the control unit 3, and processed thereby. It is of course also possible for the camera 2 to already perform some preprocessing, such as noise reduction or the like. For convenience, it is assumed in the present embodiment that the image processing device is located in the control unit 3, and carries out all image processing. The image processing device will therefore not be further referred to separately from the control unit 3. All of this will be explained in more detail below.

The control unit 3 generates calving information on the basis of the image processing. Depending on the calving information, the alert device 4 may send an alert message to a mobile telephone 5, for example, or to another device belonging to a user, such as a livestock farmer. The alert message comprises, for example, the calving information, or even a warning that the cow C in the calving pen A needs help, or at least should be investigated or visited.

The operation of the system 1 according to the invention will now be explained in more detail with reference to FIGS. 2 and 3.

FIG. 2A shows an example of a camera image 10 from the camera 2. Here, 6 indicates the torso, 7 the udder, 8a and 8b the hind legs, 9 the tail, 10 the head and 11a and 11b the forelegs. 12 indicates a collar. The dashed lines indicate borders between said animal parts.

The image 10 shows the cow C, as recognised by the control unit therein. This recognition can take place using any kind of algorithms, in particular such as “learning” using a neural network, as known per se in the art of object recognition. Furthermore, the control unit can be taught in this way to recognise animal parts in the image of the cow C. For the present invention, the torso 6 is of particular importance. Preferably, this will be distinguished from the rest of the cow C, here the udder 7, the hind legs 8a, b, the tail 9, the head 10 and the forelegs 11a, b. In FIG. 2A, these parts of the torso 6 are divided up using (imaginary) dashed lines.

Not all of these animal parts are always visible in the image. For example, the udder 7 will not be visible in an image of the cow as shown in FIG. 1. The torso 6, as the largest part by far, will of course always be visible. It is also the most important part of the animal for the present invention, since the contractions, and indeed the entire calving process, take place there.

Furthermore, it is useful to know the orientation of the torso 6. For this, the control unit can look for the short and long axis of the torso 6, and for the “head” and “tail” animal parts. Additionally, it may help, particularly if the tail 9 is covered, and if the tail 9 and the head 10 are over the torso 6 or another animal part and are thus difficult to recognise, to recognise the collar 12. This is in principle virtually always partly visible, and is of course at the head end.

With the animal image segmented in this way, the control unit then gets to work, and then actually only using the torso 6. This is shown in FIG. 2B, together with two dashed lines 20a, b, which indicate the long and short axes, respectively, and a dot-dashed line 21.

In one embodiment, the control unit is configured to determine the width of the torso 6 as a function of time. For this, the control unit can for example determine, in each image, the length of the short axis 20b in the image. If the cow does not move, the change in the width, such as in the case of a contraction, can thus be readily determined. If the cow does move, the magnification ratio may change, since the animal assumes another distance with respect to the camera, which may be somewhat disruptive. This can be overcome by determining not the width, but the ratio of the width to the length of the torso, as the length of the short axis 20b divided by the length of the long axis 20a. It should be noted that the long axis 20a can change if the cow assumes another posture. However, such influences are difficult to completely eliminate in the case of living beings.

To some advantage, the control unit is configured to consider only the most relevant part of the torso, and in a first approximation that is the rearmost part, roughly the tail-end half. It should be noted that this does not necessarily have to be exactly half in terms of area or length. Practical measurements can indicate which part is the most relevant. In FIG. 2B, this corresponds approximately to the portion to the left of the line 20b. Indeed, no contractions will occur in the foremost part of the torso, but instead just breathing. Although the latter are per se readily distinguishable from contractions, it is more advantageous not to have to consider them at all. It is even more advantageous when the control unit is configured to measure parameter values in pixels of a sub-part of said rearmost part of the torso, for example the sub-part that goes from a perpendicular bisector of the longitudinal axis 20a to the udder (segment 7 in FIG. 1). This sub-part comprises the womb, out of which the calf is pushed by the contractions. Of course, there are also other possible ways to define an even more relevant sub-part for the consideration of pixels by the control unit.

In particular embodiments, the control unit is configured to consider the width only in that part of the torso, or of the rearmost part of the torso, where the contractions are most prominent. Using this measure too, as many other, non-contraction movements as possible can be excluded. For this, the control unit can again be trained using a neural network or the like, for example, or the control unit can initially analyse a number of sets of images per animal type or even per animal, and, for example, measure the variation in width over time for a whole host of spots distributed over the longitudinal axis of the torso. Since the contractions are of course seen at the same time in the images, it is relatively straightforward to determine the spot along the longitudinal axis 20a where the contractions are most clearly visible, because the variation, whether in the absolute or relative sense, is the most clearly visible. In the present example, it turned out that the contractions were most clearly visible at the location of the dot-dashed line 21. Moreover, it is of course also possible to choose an area instead of a spot for consideration, or an easy-to-follow line that forms a good approximation of the most clearly visible spot. Thus, in the present example, the line 20b can also be taken as being the perpendicular bisector of the longitudinal axis 20a. The longitudinal axis is then the longest line segment that can be drawn in the torso 6, and the length of the line segment 20b along the perpendicular bisector of that line segment 20a is then the effective “width”.

In any case, the result of the above-mentioned method is that a numerical value is determined per image, namely either the absolute width or the relative width. Analysis of this numerical value will be explained further on in the text with the aid of FIG. 3.

In FIGS. 3A and 3B, the determined signals are plotted against time (solid line) and against a fitted function (dashed line) in each case, in a respective diagram.

In this case, the signals are the respective numerical values for the images taken in the predetermined period plotted in arbitrary units on the y-axis. The numerical values are here the width minus a (minimum) width at the start of the images, all to make the variation clearer. The sequence number of the images is given as the time on the x-axis. For example, there are 75 images in such a predetermined period. At 5 images per second, that corresponds to 15 seconds. FIG. 3A relates to a lying cow having two contractions, and FIG. 3B relates to a cow not having contractions, which, for example, is randomly moving or lying down.

As described above, the signal is in particular the measured width value of the torso. In the case of a cow in a standing or lying position, the width will then vary regularly. This can be seen clearly in FIG. 3A, where the solid line exhibits periodic behaviour.

The control unit can, if so programmed, continue with a further analysis of the signal by fitting a periodic function to the signal. The most obvious in the case of a periodic biological signal is a sine function, or at least a sinusoidal function. Fit parameters are, inter alia, the frequency (or period), the phase shift, a multiplication factor and a zero offset. However, there is certainly a possibility for some variation here, and in the output fit function. In FIG. 3A, the period is approximately 30 images, or 6 seconds. This is within the normal range for contractions in cows, and is thus a good candidate for detection by the control unit as contractions.

Additionally, the peak height (here about 30) with respect to the trough signal (around 10) and the width of the signal (here around 8 at FWHM) can be considered. In the figures shown here, these are shown in arbitrary units, and so it is not readily possible to provide general indications here as to what is likely to be and not to be a contraction, all the more because this also depends on the properties of the camera, the lighting, and in some cases even the substrate, etc. Nevertheless, it is in practice readily possible, by means of training and/or comparison with images and signals with assessments by, for example, vets or livestock farmers, to give reliable limits or ranges for the values of (relative or absolute) peak heights and peak widths.

FIG. 3B shows the signal S in the case of a cow that is lying down, again with a dashed line. Since the cow is lying down, the measured width of the torso, because of the change in appearance among other things, will suddenly change significantly. This has nothing to do with contractions, as can also be seen in the non-periodic behaviour of the largest part of the change. Still, some change seemingly with a periodicity is visible, as apparent from the best fit with the periodic function, indicated by the dashed line, but it will be clear that such a periodic signal is outweighed by the non-periodic part of the change, and for this reason will never or hardly ever count as a reliable detection of contractions. It should be noted that a small change, for example as a result of breathing or the like, will likewise give a periodic change, at approximately the same frequency, but this will generally give a weaker signal. Even a further analysis, by calculating the width and height of the peaks, will in this case not lead to the control unit detecting contractions.

On the basis of any of the possibilities described above, the control unit can determine parameter values from the images taken and subsequently conclude whether contractions are occurring. The control unit can deal with a current period, and each time again determine contractions therefrom. Each time, the control unit can conclude “contractions” for a number of images, and thus also for the corresponding points in time, and store these points in time or time periods in which they occur in a database. Thus, the control unit is advantageously configured to detect and determine contractions, in terms of number and/or time duration, over a longer measuring period, for example set by a user on the basis of the expected calving time or the like. Furthermore, the control unit can be configured to generate calving information on the basis of these data, such as for how long calving has already been under way, what the contraction frequency is, etc. The control unit can be configured to send this information via the alert device 4 of FIG. 1 to the livestock farmer, for example, in the form of an SMS, push or email message. Depending on certain conditions, this can also be in the form of an alert message, such as “contractions lasting too long”, “contractions have stopped” or the like.

The embodiments described above are to be considered only by way of explanation of the present invention, and as non-limiting for the scope of protection of the invention. The scope of protection is determined by the attached claims.

1. A calving monitoring system for monitoring an animal at an end of an expected gestation period, comprising:
a camera device for repeatedly taking images of the animal over a predetermined time duration, said images being composed of pixels,
a control unit for the calving monitoring system, connected to the camera device, which is configured to generate calving information from the images taken, and
an alert device for sending an alert message according to the calving information generated,
wherein the control unit is configured so as, in each image taken,
to recognise an animal image,
to segment said animal image into multiple animal parts including a torso,
to determine a parameter value relating to first pixels of said torso in said taken images as a time-dependent parametric function, wherein said parameter value comprises a width value of the torso, and
to detect contractions when said parameter value meets a predetermined contraction criterion, the criterion being that the parameter value exhibits at least two peaks in said predetermined time duration which have at least a predetermined minimum width and/or a predetermined minimum height,
wherein the control unit generates calving information which comprises an indicator of the contractions detected.

2. The calving monitoring system according to claim 1, wherein said first pixels are all in a part of the torso located at a rearmost end of the animal image.

3. The calving monitoring system according to claim 1, wherein the control unit is configured to determine a longitudinal direction of the torso, and to determine the width value as equal, or proportional, to a width measured transverse to the longitudinal direction.

4. The calving monitoring system according to claim 3, wherein the width value is a normalised width value.

5. The calving monitoring system according to claim 1, wherein the control unit is further configured to
carry out an analysis of said parametric function, comprising fitting a periodic function with a period p to said parametric function,
determine at least one fit parameter value of a fit parameter and the correlation between the fitted function and the parametric function, and to
correct the number of contractions detected according to said at least one fit parameter value.

6. The calving monitoring system according to claim 1, wherein the alert device is configured to send a calving phase warning if a frequency of the contractions detected and/or a total cumulative time duration of the contractions detected, in each case over at least an immediately preceding, predetermined observation period, reaches or exceeds a predetermined frequency threshold or first time threshold, respectively.

7. The calving monitoring system according to claim 1, wherein the alert device is configured to send a calving difficulty warning if the time duration over which the control unit detects contractions reaches a predetermined threshold calving duration.

8. The calving monitoring system according to claim 1, wherein said first pixels are all in a half of the torso located at a rearmost end of the animal image.

9. The calving monitoring system according to claim 4, wherein the width value is a normalised width value is equal to said width of the torso divided by a length of the torso measured along the longitudinal direction.

10. The calving monitoring system according to claim 5, wherein the one fit parameter value comprises at least one of the difference between the fitted function and the parametric function.
